(19) United States
(12) Patent Application Publication
(10) Pub. No.: US 2002/0082834 A1
(43) Pub. Date: Jun. 27, 2002

(54) Simplified and robust speech recognizer

(76) Inventors: George Paul Eaves, Richardson, TX (US); Geoffrey James Martindale, Richardson, TX (US)

Correspondence Address: TEXAS INSTRUMENTS INCORPORATED, P O BOX 655474, M/S 3999, DALLAS, TX, 75265

(21) Appl. No.: 10/004,395

(22) Filed: Nov. 15, 2001

Related U.S. Application Data
(60) Provisional application No. 60/249,384, filed on Nov. 16, 2000.

(51) Int. Cl. G10L 15/04

(52) U.S. Cl. 704/251

(57) ABSTRACT

Systems and methods are provided for speech recognition. The systems and methods are operative to evaluate a spoken word and determine one or more characteristics of a speech waveform corresponding to the spoken word. The speech waveform is converted to a digital pulse waveform based on a threshold level. One or more characteristics of the speech waveform can be analyzed utilizing the digital pulse waveform. The threshold level can be adjustable so that varying voltage amplitudes of speech waveforms can be considered. The one or more characteristics can be matched with one or more stored characteristics to determine the spoken word associated with the speech waveform between a set of selectable words having different waveform characteristics.

### CROSS REFERENCE TO RELATED APPLICATIONS

The present application claims the benefit of U.S. Provisional Patent Application Ser. No. 60/249,384, filed Nov. 16, 2000, entitled SIMPLIFIED AND ROBUST YES/NO SPEECH RECOGNIZER, and which is incorporated herein by reference.

### TECHNICAL FIELD

The present invention relates to speech recognition and more particularly to systems and methods for distinguishing between a set of words using a simplified and robust speech recognizer.

### BACKGROUND OF INVENTION

Speech and voice recognitions systems have recently increased in popularity and are now used regularly in computer based user interface systems such as voice activated dialing and telephone menu systems. Conventional speech recognition systems typically match spoken words to words stored in a vocabulary list and utilize complicated statistical models to store the waveform representation of the word in memory. The stored waveform representation of the word typically requires a large volume of memory for a small vocabulary and even larger volumes of memory for a large vocabulary. The conventional speech recognition systems employ expensive analog-to-digital (A/D) converters. Additionally, conventional speech recognition systems and methods utilize pattern matching techniques to make a determination between a spoken word and the waveform representation of that word in memory.

For example, spectral analysis techniques can be used to map the spectral components of an input word to the spectral components of stored representations of words. A variety of other mathematical analysis and matching techniques have been employed to discern between word sets. These mechanisms for determining between spoken words are computationally expensive and time consuming and require complicated hardware devices and software algorithms. Some implementations (e.g., toy applications, simple menu systems, Yes/No enabled devices, mobile communication devices) of speech recognition systems only require a determination between a small set of words. Therefore, only a limited vocabulary list is needed. However, the expense of conventionally speech recognition systems and methods for discerning between a small set of words is prohibitively expensive for some lower cost implementations.

The conventionally speech recognition systems and methods are also not feasible for some smaller devices and battery operated devices due to weight requirements, electrical power requirements, complexity and cost. Therefore, simpler, less expensive speech recognition systems and methods are desirable.

### SUMMARY OF INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides for systems and methods for speech recognition. The systems and methods are operative to evaluate a spoken word and determine one or more characteristics (e.g., amplitude, frequency, duration) of a speech waveform corresponding to the spoken word. The speech waveform is converted to a digital pulse waveform based on a threshold voltage or threshold level. One or more characteristics of the speech waveform can be analyzed utilizing the digital pulse waveform. The threshold level can be adjustable so that varying voltage amplitudes of speech waveforms can be considered. The one or more characteristics can be matched with one or more stored characteristics (e.g., word profiles) to determine the spoken word associated with the speech waveform between a set of selectable words having different waveform characteristics.

In one aspect of the invention, a circuit is provided for converting a speech waveform into a digital pulse waveform. The circuit includes a comparator that converts the speech waveform into a digital pulse waveform based on a threshold level set by a threshold level shifter circuit. The threshold level shifter circuit is operative to change the threshold voltage or threshold level provided to the comparator. In this way, portions of the speech waveform having different voltage amplitudes can be analyzed. The state of the threshold level shifter circuit is controlled by a digital signal from a digital circuit or device to provide two or more different threshold voltages to the comparator.

An analysis system (e.g., programmed microcontroller, control logic component) can be provided for analyzing characteristics of the digital pulse waveform in addition to controlling the state of the threshold level shifter circuit. The analysis system can determine one or more characteristics associated with the digital pulse waveform and match these characteristics with one or more stored characteristics to determine a spoken word from a set of selectable words. The analysis can then provide a desired action based on the matched word.

The following description and the annexed drawings set forth certain illustrative aspects of the invention. These aspects are indicative, however, of but a few of the various ways in which the principles of the invention may be employed. Other advantages and novel features of the invention will become apparent from the following detailed description of the invention when considered in conjunction with the drawings.

### BRIEF DESCRIPTION OF THE DRAWINGS

FIG. 1 illustrates a block diagram of a speech recognition system in accordance with an aspect of the present invention.

FIG. 2 illustrates characteristics associated with a speech waveform for the spoken word “NO”.

FIG. 3 illustrates characteristics associated with a speech waveform for the spoken word “YES”.

FIG. 4 illustrates a block diagram of an alternate speech recognition system employing an analysis system in accordance with an aspect of the present invention.

FIG. 5 illustrates a block diagram of a control logic component in accordance with an aspect of the present invention.

FIG. 6 illustrates a schematic diagram of a conversion and level shifting circuit in accordance with an aspect of the present invention.

FIG. 7 illustrates a schematic diagram of a threshold level shifter circuit that moves the threshold level for a comparator circuit in accordance with an aspect of the present invention.

FIG. 8 illustrates a schematic diagram of a threshold level shifter circuit operative to provide three threshold levels in accordance with an aspect of the present invention.

FIG. 9 illustrates a flow diagram of a methodology for distinguishing between spoken words in accordance with an aspect of the present invention.

FIG. 10 illustrates a flow diagram of a methodology for distinguishing between two words where one word has a voiced portion and unvoiced portion and the other word has only a voiced portion in accordance with an aspect of the present invention.

### DETAILED DESCRIPTION OF THE INVENTION

The present invention will be described with reference to systems and methods for speech recognition. The systems and methods are operative to evaluate a spoken word and determine one or more characteristics (e.g., amplitude, frequency, duration) of a speech waveform corresponding to the spoken word. The systems and methods do not employ high resolution A/D converters or complicated mathematical algorithms to discern between the spoken words, but utilize simple profiles based on waveform characteristics of the spoken words to discern between different words in a set. The systems and methods can be employed in many different devices, without the computational power and memory requirements, high power consumption, complex operating system, high costs, and weight of conventional systems. Therefore, the systems and methods are well suited for applications such as person-to-person and person-to-machine communication for mobile phones, PDAs, electronic toys, entertainment products, educational aids, communication systems and any other devices requiring speech recognition.

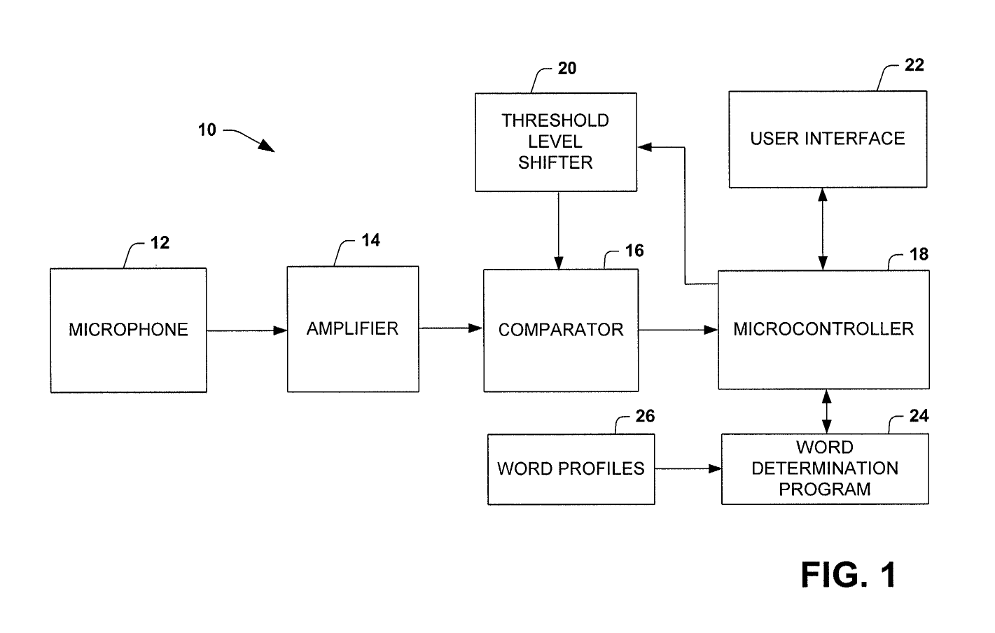

FIG. 1 is a schematic block diagram illustrating a speech recognition system 10 in accordance with an aspect of the present invention. The speech recognition system 10 is able to discern between a small set (e.g., 2, 3, 4) of spoken words having different waveform characteristics (e.g., amplitude, frequency, duration). The speech recognition system 10 includes a user interface 22 that prompts a user to speak a word from a set (e.g., 2, 3, 4) of words. For example, the user can be prompted to say “YES” or “NO”, “TRUE or “FALSE”, “STOP” or “GO”. The system 10 is operative to transform the spoken response into a useable electrical signal, such as a speech waveform that represents the spoken response, and determine the selected spoken response by analyzing one or more characteristics of the speech waveform. The system then compares the one or more characteristics to a set of simple word profiles containing one or more characteristics about the speech waveforms of the set of selectable words.

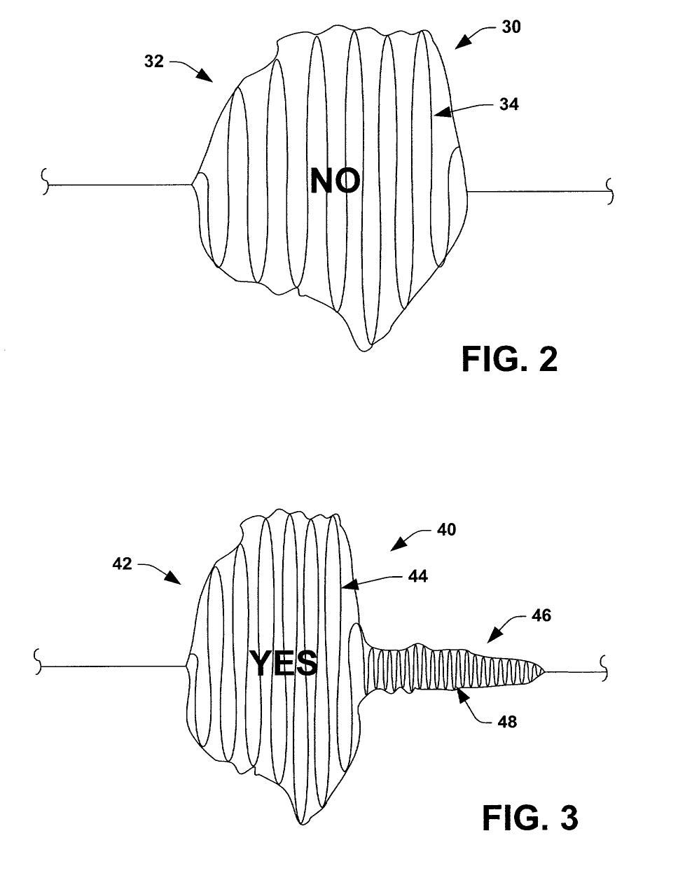

The speech recognition system 10 includes a microphone 12 that transforms spoken words into an electrical signal. The electrical signal is provided to an amplifier 14, which amplifies the electrical signal from the microphone 12 and produces a speech waveform with distinguishable characteristics. The speech waveform has a number of characteristics associated with the speech waveform. FIGS. 2-3 illustrate characteristics associated with a speech waveform 30 for the spoken word “NO” (FIG. 2) and a speech waveform 40 for the spoken word “YES” (FIG. 3). The speech waveform 30 of FIG. 2 includes a voiced portion 32 having a plurality of modulations 34. Speech includes voiced portions with distinct pitch and unvoiced portions without distinct pitch. The voiced portion 32 has a larger voltage amplitude than an unvoiced portion. The speech waveform 30 includes a plurality of modulations 34 that have an associated voltage amplitude and frequency that can be measured and compared. The speech waveform 30 also has a time duration associated with the speech waveform 30 and the plurality of modulations 34. One or more of these characteristics can be employed to profile the speech waveform 30.

The speech waveform 40 of FIG. 3 includes a voiced portion 42 and an unvoiced portion 46. The voiced portion 42 includes a plurality of modulations 44 that have an associated voltage amplitude and frequency that can be measured and compared. The unvoiced portion 46 includes a plurality of modulations 48 that have an associated voltage amplitude and frequency that can be measured and compared. The plurality of modulations 48 have a higher frequency and lower amplitude than the plurality of modulations 44. The speech waveform 40 also has a time duration associated with the plurality of modulations 44 and the plurality of modulations 48. One or more of these characteristics can be employed to profile the speech waveform 40. The present invention utilizes theses characteristics to create a simple profile based on one or more characteristics of a speech waveform and uses the profile to determine which word from a set of words was spoken. The use of a simple profile alleviates the need to store large reproductions of the words in memory in addition to complex mathematical analysis to discern between spoken words.

Referring again to FIG. 1, the speech recognition system 10 also includes a comparator 16 operative to receive the speech waveform signal and provide a digital pulse waveform corresponding the plurality of modulations associated with the speech waveform that exceed a threshold level. The digital pulse waveform is provided to a microcontroller 18, which is programmed to perform a word determination program 24. The word determination program 24 can be stored in external memory or be stored in memory resident in the microcontroller 18. The microcontroller 18 can be programmed to count the number of pulses in the digital pulse waveform based on a predetermined time period or frame (e.g., 20 ms) to determine the frequency of the plurality of modulations. Alternatively, or additionally, the microcontroller 18 can be programmed to count the time between pulses to determine the frequency of the plurality of modulations.

The microcontroller 18 can also be programmed to control a threshold level shifter 20. The threshold level shifter 20 controls the threshold level required for the output of the comparator 16 to toggle. Programming of the threshold level shifter 20 can be utilized to distinguish between voiced portions (higher voltage amplitude modulations) and unvoiced portions (lower voltage amplitude modulations). Once the programmed microcontroller 18 has determined enough of the one or more characteristics for the set of available words, the microcontroller 18 via the word determination program 24 compares the one or more characteristics to a set of word characteristic profiles 26. The word corresponding to the speech waveform profile is determined and appropriate action is taken, such as a response to the user's selection can be provided on the user interface.

For example, if the speech recognition is adapted to distinguish between a “YES” speech waveform and a “NO” speech waveform, the controller can be programmed as follows. The microcontroller 18 sets the threshold level shifter 20 to a high threshold level to determine if a voiced portion of a speech waveform has been received. Once it is determined that a voiced portion has been received, the microcontroller 18 begins counting the number of pulses corresponding to the number of modulations in the speech waveform, for example, using a counter. The microcontroller 18 then reads the counter periodically based on a time period or frame (e.g., about 20 ms). If it is determined that the number of counts fall within a certain range, the counter is reset and the reading repeated for the next frame. This is repeated for a predetermined number of frames (e.g., 3 or more frames), until it is determined that the speech recognition system 10 has received a voice portion of a speech waveform. Alternatively, this can be repeated until the count falls below the range or to zero indicating the end of the voiced portion.

The microcontroller 18 then sets the threshold level shifter 20 to a lower threshold level to look for an unvoiced portion of the speech waveform. Again, the counter is reset and read periodically based on a time period or frame (e.g., about 20 ms). Since the frequency of the unvoiced portion is much higher than the voiced portion, the count is compared with a different count range until an unvoiced portion is determined or the count falls below a certain count level indicating that the speech waveform does not have an unvoiced portion. Therefore, a determination can be made between which word was spoken. The above is just one program methodology that can be utilized to distinguish between a “YES” speech waveform and a “NO” speech waveform. The same methodology can be utilized to distinguish between a “TRUE” and “FALSE” speech waveform. The methodology can also be inverted for terms such as “STOP” and “GO” where “STOP” has an unvoiced portion followed by a voiced portion and “GO” has only a voiced portion.

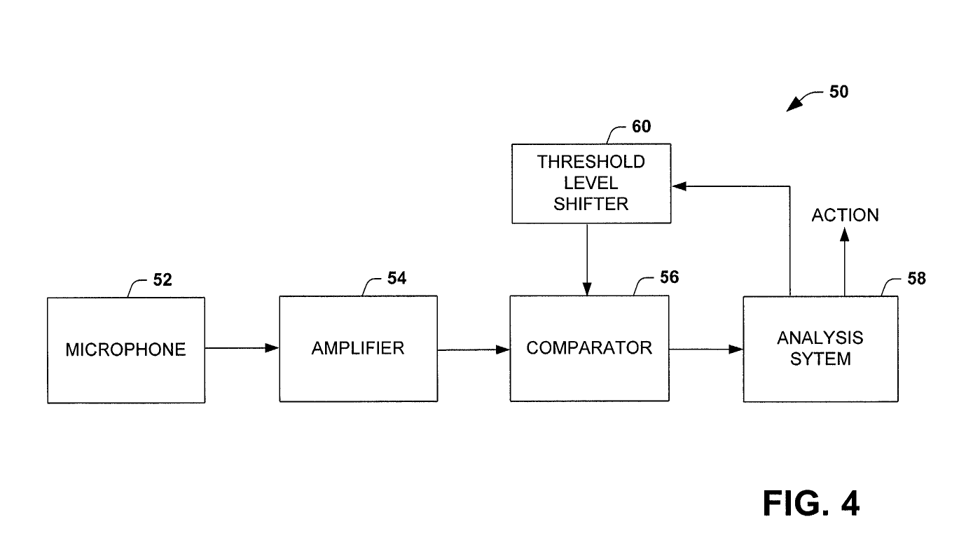

FIG. 4 is a schematic block diagram illustrating a speech recognition system 50 in accordance with another aspect of the present invention. The speech recognition system 50 is able to discern between a set (e.g., 2, 3, 4) of spoken words having different waveform characteristics (e.g., amplitude, frequency, duration). The system 50 is operative to transform a spoken word into a usable electrical signal, such as a waveform that represents the spoken word and determine which of a set of words matches the speech waveform by analyzing one or more characteristics of the speech waveform, and comparing the characteristics to a simple word profile containing one or more characteristics about the speech waveform. The speech recognition system 50 includes a microphone 52 that transforms a spoken word into an electrical signal. The electrical signal is the provided to an amplifier 54, which amplifies the electrical signal from the microphone 52 and produces a speech waveform having distinguishable characteristics.

The speech waveform has a number of characteristics associated with the speech waveform, such as amplitude, frequency and duration of the waveform modulations in addition to the duration of a portion of the waveform or the whole waveform. One or more of these characteristics can be employed to profile one or more speech waveforms for determining the spoken word.

The speech recognition system 50 also includes a comparator 56 operative to convert the speech waveform signal into a digital pulse waveform corresponding to the plurality of modulations associated with the speech waveform that exceeds a threshold level. The digital pulse waveform is provided to a waveform analysis system 58, which provides the necessary functionality for discerning between spoken words based on one or more characteristics associated with the speech waveforms. The waveform analysis system 58 can count the number of pulses in the digital pulse waveform based on a predetermined time period or frame to determine the frequency of the plurality of modulations. Alternatively, or additionally, the waveform analysis system 58 counts the time between pulses to determine the frequency of the plurality of modulations.

The waveform analysis system 58 can control a threshold level shifter 60. The threshold level shifter 60 controls the threshold level required for output of the comparator 56 to toggle. Control of the threshold level shifter 60 can be utilized to distinguish between voiced portions (higher voltage amplitude modulations) and unvoiced portions (lower voltage amplitude modulations). Once the waveform analysis system 58 has determined enough of the one or more characteristics for the set of available words, a determination is made by comparing the determined characteristics to a set of characteristics or waveform profiles associated with the selectable words. An appropriate action is then taken by the waveform analysis system 58 based on the determination.

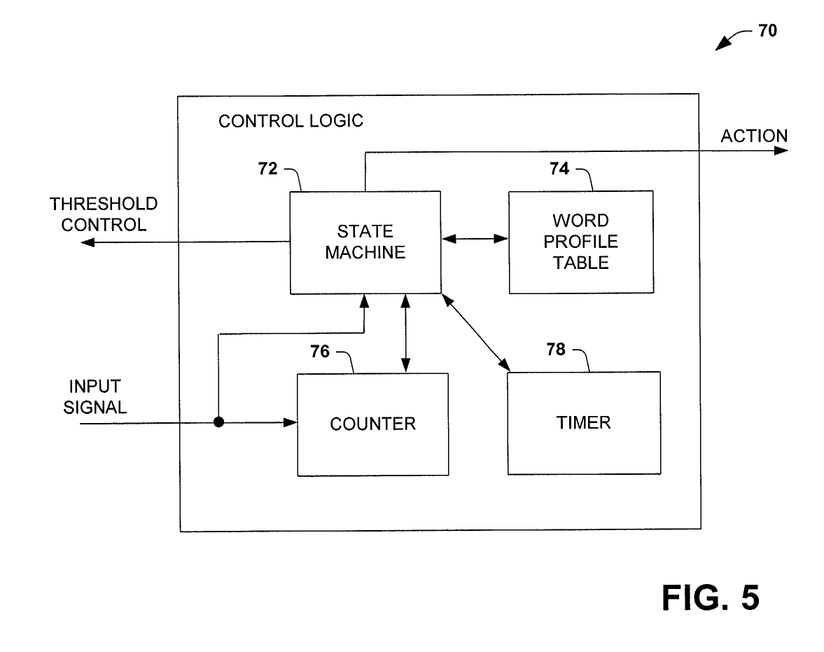

It is to be appreciated that the analysis system of FIG. 4 can be provided via the programmed microcontroller of FIG. 1 or alternatively through a control logic component. FIG. 5 illustrates a block diagram of a control logic component 70 in accordance with an aspect of the present invention. The control logic component 70 includes a state machine 72 that executes logic associated with analyzing a digital pulse waveform signal corresponding to pulse modulations of a speech waveform. The digital pulse waveform signal is sensed by the state machine 72 which enables a counter 76. The counter 76 counts the number of pulses associated with the digital pulse waveform. The state machine 72 uses a timer 78 to determine when to check the counter 76 for count values based on the number of pulses determined. The state machine 72 also uses the timer 78 to determine the time between pulses.

The state machine 72 provides a threshold control signal that modifies the threshold level used to determine the plurality of modulations associated with the speech waveform that exceeds a threshold level. The threshold control signal provides a mechanism for indirectly determining voltage amplitude of a speech waveform by varying a threshold level, for example, of a comparator. Once the state machine 72 has determined one or more characteristics of the speech waveform by analyzing the digital pulse waveform, a determination can be made on which of a set of words that the speech waveform corresponds. The state machine 72 compares the one or more characteristics with one or more characteristics stored in a word profile table 74. The state machine 72 then makes a determination of which of the set of words matches the speech waveform. Once the correct word is selected an action is performed based on the matched word. It is to be appreciated that multiple actions can be performed based on a matched word.

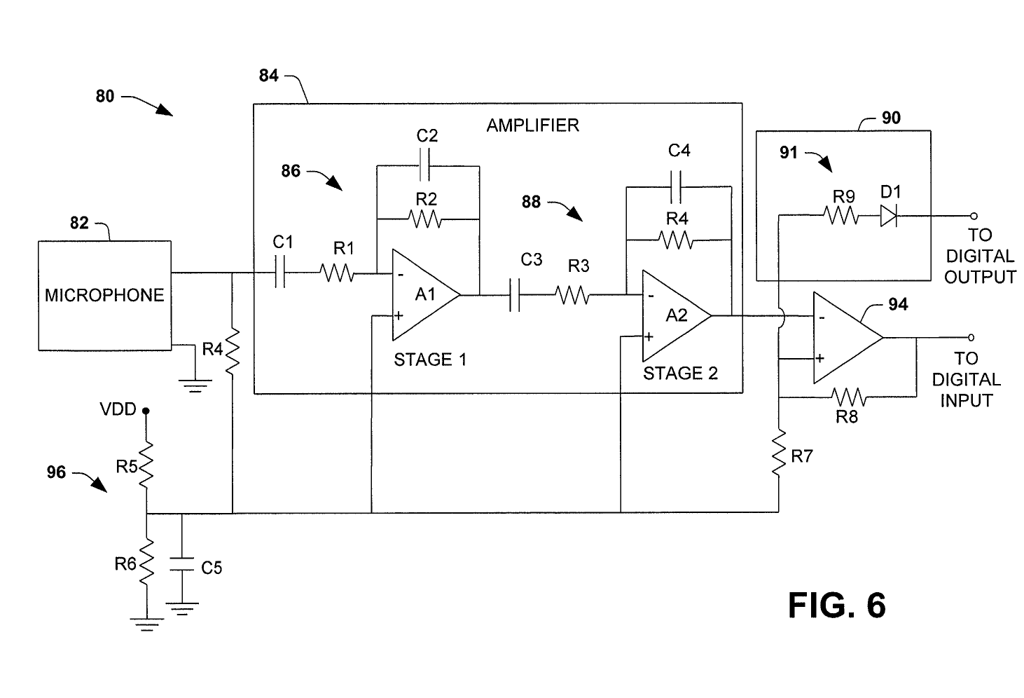

FIG. 6 illustrates a schematic diagram of a circuit 80 that transforms a speech waveform into a digital pulse waveform. The circuit 80 also facilitates control of a threshold level to a comparator that converts a speech waveform into a digital pulse waveform. The circuit 80 receives a spoken word from a microphone 82. The microphone 82 transforms the spoken word into an electrical signal. The microphone 82 is coupled to an amplifier device 84 having a first amplifier stage 86 and a second amplifier stage 88. The microphone 82 is coupled to the first amplifier stage 86 through a capacitor C1 (e.g., 1 μF capacitor) and a resistor R1 (e.g., 3.3K resistor). The first amplifier stage 86 is coupled to the second amplifier stage 88 through a capacitor C3 (e.g., 1 μF capacitor) and a resistor R3 (e.g., 3.3K resistor).

The first amplifier stage 86 includes an amplifier A1 having a resistor R2 (e.g., 156K resistor) and capacitor C2 (e.g., 330 pf capacitor) coupled from the output to a negative terminal of the amplifier A1. The resistor R2 and R1 set the gain of the amplifier A1, while the capacitor C1 provides a high pass filter and the capacitor C2 provides a low pass filter. A positive terminal of the amplifier A1 is coupled to a voltage divider 96 comprised of resistors R5 and R6. The voltage divider 96 provides a DC bias to the amplifier A1, which will be referred to as the zero crossing level. A capacitor C5 (e.g., 1 μF capacitor) is coupled to the voltage divider 96 between R5 and R6 and ground.

The second amplifier stage 88 includes an amplifier A2 having a resistor R4 (e.g., 156K resistor) and capacitor C4 (e.g., 330 pf capacitor) coupled from the output to a negative terminal of the amplifier A2. The resistor R4 and R3 set the gain of the amplifier A2, while the capacitor C3 provides a high pass filter and the capacitor C4 provides a low pass filter. A positive terminal of the amplifier A2 is coupled to the voltage divider 96 comprised of resistors R5 and R6. The voltage divider 96 provides a DC bias or zero crossing level to the amplifier A2. The output of the amplifier 84 is coupled to a negative terminal of a comparator 94.

The amplifier 84 and the components of the amplifier 84 are selected to provide an appropriate gain and bandwidth to the electrical signal to produce a speech waveform within distinguishable voltage and frequency ranges. It is to be appreciated that a variety of different amplifier types can be selected and a variety of component values can be chosen based on the particular implantations being employed, as would be apparent to those skilled in the art.

The output of the amplifier 84 produces a speech waveform corresponding to a spoken word, which is provided as an input to the comparator 94 at its negative input terminal. A positive terminal of the comparator 94 is coupled to the voltage divider 96 through a resistor R7 (e.g., 10K resistor). A resistor R8 (e.g., 3.9M resistor) is connected from the positive terminal to the output of the comparator 94 to provide for hysteresis associated with the comparator 94. It is to be appreciated that a variety of comparator circuits having a variety of different component values can be provided to produce a digital pulse waveform from a speech waveform.

The positive terminal of the comparator 94 is also coupled to a threshold level shifter circuit 90. The threshold level shifter circuit 90 controls the threshold level required for the output of the comparator 94 to toggle. A single digital output pin of a microcontroller or control logic component can be utilized to control the state of the threshold level shifter circuit 90 and as a result the threshold level provided to the comparator 94. Changing the state of the threshold level shifter circuit 90 can be utilized to distinguish between voiced portions (higher voltage amplitude modulations) and unvoiced portions (lower voltage amplitude modulations) of the speech waveform.

The threshold level shifter circuit 90 includes a resistor-diode pair 91 comprising R9 (e.g., 10K resistor) and a diode D1. The cathode of the diode D1 is connected to a digital output pin, while the anode is connected to resistor R9. A high digital signal on the digital output pin provides for a first threshold level based on a voltage provided by the voltage divider pair 96 to the positive terminal of the comparator 94. For example, if VDD is +5 Volts and R5 and R6 have substantially equal resistive values, then the threshold level provided to the comparator 94, when the digital output pin is high, would be about +2.5 volts or the zero crossing level. This threshold level is the lowest level, since a low input signal would toggle the output of the comparator and generate digital pulses.

A low digital signal on the digital output pin provides for a second threshold level to the positive terminal of the comparator 94. The second threshold level is based on a voltage provided by the voltage divider pair 96 and the voltage provided by a second voltage divider pair formed by R7 and R9. For example, if VDD is +5 Volts, R5 and R6 have substantially equal resistive values, and R7 and R9 have substantially equal resistive values, then the second threshold level, when the digital output pin is low, would be about +1.55 volts ((2.5−0.6)/2+0.6) assuming about a 0.6 volt drop of the diode D1. This threshold level is the higher level, since it requires a signal greater than 1.8 volts peak to peak to toggle the output of the comparator and generate digital pulses.

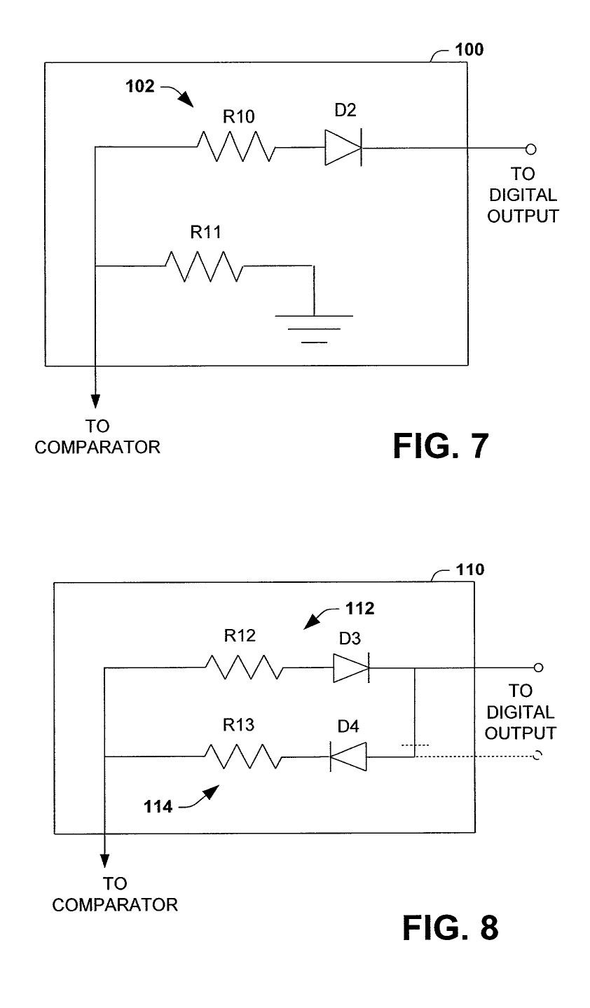

It is to be appreciated that it may be desirable in certain implementations to vary the threshold level to compensate for background noise. FIG. 7 illustrates a threshold level shifter circuit 100 operative to compensate for background noise in accordance with an aspect of the present invention. The threshold level shifter circuit 100 comprises a resistor R 11 (e.g., 47K resistor) connected on one end to a resistor-diode pair 102 and connected to ground on its other end. The resistor-diode pair 102 includes a resistor R10 (e.g., 10K resistor) and a diode D2. The cathode of the diode D2 of the resistor-diode pair 102 is connected to a digital output pin, while the anode is connected to the resistor R10. The resistor R11 increases the low threshold voltage setting from the zero crossing level, so that background noise will not cause a false reading when monitoring an unvoiced detection. It is to be appreciated that the value of the resistor R11 can be selected based on the particular implementation being employed and the anticipated environment that the implementation will experience. For example, a different component value can be selected if it is desired to move the threshold level even lower or not as low.

It is to be appreciated that it may be desirable in certain implementations to provide for three or more threshold levels. FIG. 8 illustrates a threshold level shifter circuit 110 having a first resistor-diode pair 112 connected in parallel with a second resistor-diode pair 114. The first resistor-diode pair 112 includes a resistor R12 (e.g., 10K resistor) and a diode D3. The cathode of the diode D3 of the first resistor-diode pair 112 is connected to a digital output pin, while the anode is connected to the resistor R12. The second resistor-diode pair 114 includes a resistor R13 (e.g., 5K resistor) and a diode D4. The anode of the diode D4 is connected to the digital output pin and the cathode connected to the resistor R13. This mechanism requires a digital output pin with a high impedance mode.

For example, a programmable high (z)/output pin can be set to high impedance in addition to output high and output low. The threshold level shifter circuit 110 can then provide for another threshold level between the low and high settings. If a high impedance mode is selected, neither D3 nor D4 conduct and the zero crossing voltage is applied to the comparator. If a digital high is selected D4 conducts and R13 provides part of a voltage divider between digital high and the zero crossing voltage level. If a digital low is selected diode D3 conducts and R12 provides part of a voltage divider between digital low and the zero crossing voltage level. If a high impedance mode is not available, another digital output pin could be used. This would require each resistor-diode pair to be connected to a digital output pin as illustrated by the dotted lines in FIG. 8. The digital outputs would be sequenced such that both resistor-diode pairs are not active at the same time. The threshold level shifter circuit 110 can be employed when evaluating the voiced portions of the speech waveform when a speaker has a softer voice. It is to be appreciated that the values of the resistors in the resistor-diode pairs can be selected based on the particular implementation being employed and the anticipated environment that the implementation will experience.

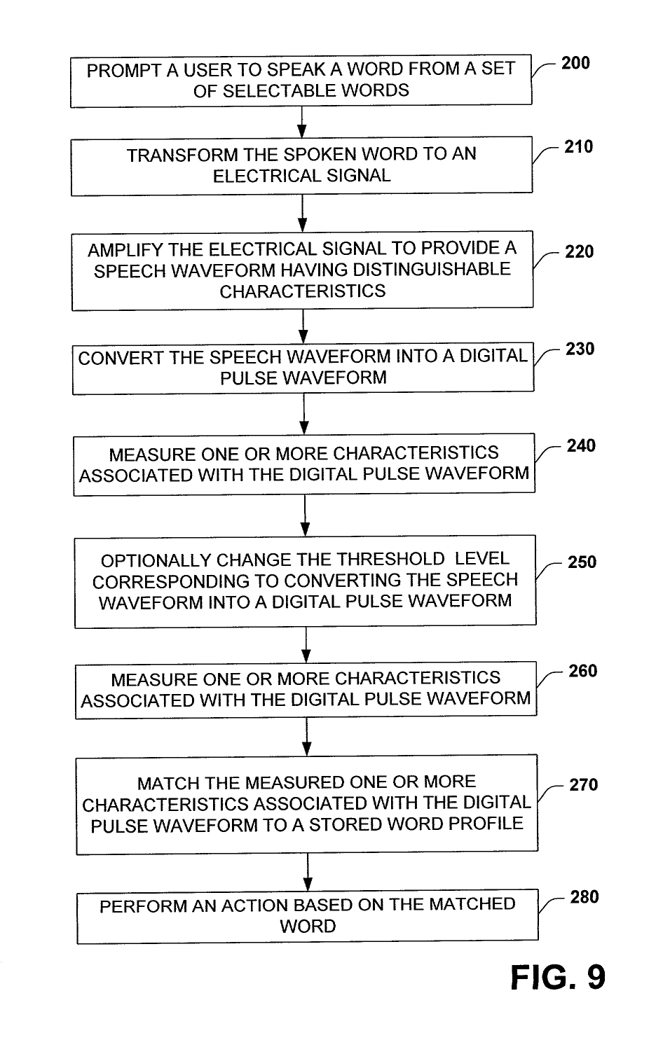

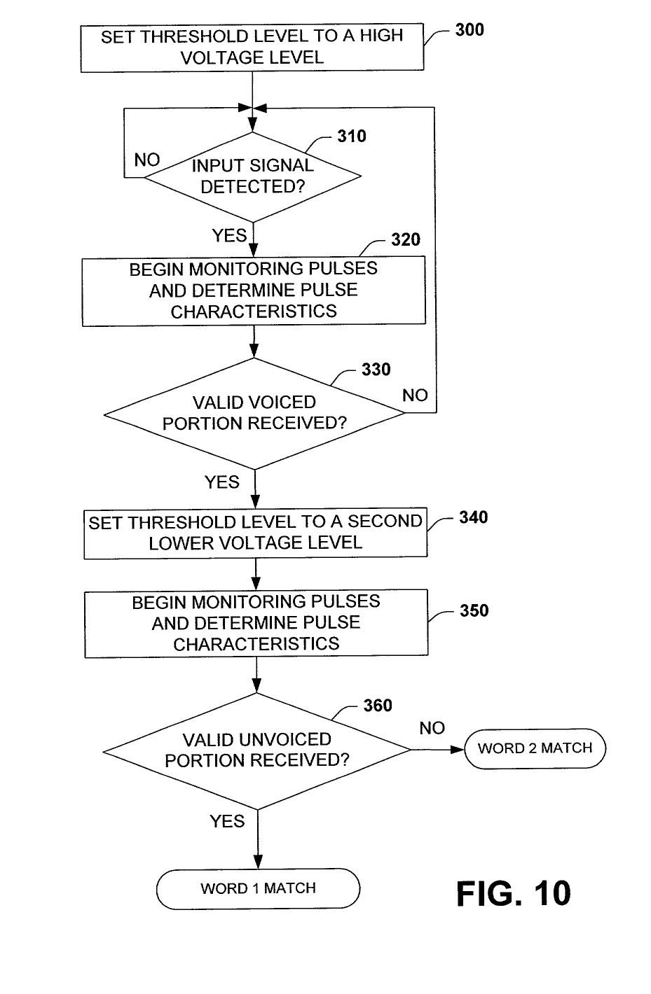

In view of the foregoing structural and functional features described above, a methodology in accordance with various aspects of the present invention will be better appreciated with reference to FIGS. 9-10. While, for purposes of simplicity of explanation, the methodologies of FIGS. 9-10 are shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 9 illustrates one particular methodology for distinguishing a spoken word between a set of selectable words. The methodology begins at 200 where a user is prompted to speak a word from a set of selectable words. At 210, the spoken word is then transformed to an electrical signal, for example, using a microphone. The electrical signal is then amplified to provide a speech waveform having distinguishable characteristics at 220. The speech waveform is then converted to a digital pulse waveform at 230. For example, the speech waveform can be input into a comparator set at a specific threshold level. The modulations of the speech waveform can then toggle the output of the comparator when the modulations have an amplitude higher than the specific threshold level. One or more characteristics associated with the digital pulse waveform are then measured at 240. The one or more characteristics can include modulation voltage amplitude levels of the speech waveform, modulation frequency of the speech waveform, voiced and unvoiced portions of the speech waveform and the duration of the speech waveform.

At 250, the threshold level corresponding to converting the speech waveform into a digital pulse waveform is optionally changed based on the associated word profiles for the selectable words. At 260, one or more characteristics associated with the pulse waveform are measured via the digital pulse waveform with the threshold voltage set at the changed voltage. At 270, a match is made with the measured one or more characteristics associated with the digital pulse waveform to stored word profile characteristics. For example, a table containing one or more characteristics about selectable words of a set of words can be provided. The characteristics can be quickly checked with the measured characteristics and a match determined. At 280, an action is performed based on the matched word.

FIG. 10 illustrates a methodology for distinguishing between two words where one word includes a voiced portion and an unvoiced portion and the other word includes a voiced portion only. The methodology can be employed to distinguish between the words “YES” and “NO” or the words “TRUE” and “FALSE”. The methodology of FIG. 10 can be implemented through software, hardware or a combination of hardware and software. The methodology of FIG. 10 is adapted to control the speech recognition system of FIG. 1, FIG. 4 and the transformation circuit of FIG. 6. The methodology begins at 300 where the threshold voltage is set at a high level to monitor for a voiced portion of a speech waveform. The voiced portion of a speech waveform typically has a lot more energy (e.g., 20-30 db higher) than an unvoiced portion. Additionally, the amplitude voltage level of a voiced portion is higher than an unvoiced portion. Therefore, the initial setting is set to a high threshold level to monitor for a voiced portion of a speech waveform.

At 310, the methodology monitors whether an input signal has been detected. If an input signal has not been detected (NO), the methodology repeats 310 until an input signal has been detected. If an input signal is detected (YES), the methodology advances to 320. At 320, the methodology begins monitoring a digital pulse waveform associated with the input signal and determining one or more pulse characteristics. For example, the pulse count can be read and can be used to determine whether the count falls within a predetermined range. For example, the count can be checked within a time period or frame (e.g., 20 ms) to determine if a valid voiced portion has been found. The validation can be repeated for a series of frames (e.g., 3 or more frames) to assure a valid voiced portion has been received. Alternatively, this can be repeated until the count falls below the range or to zero indicating the end of the voiced portion. The frequency of the pulses can be measured and this used to determine if a valid voice portion has been received. The methodology then proceeds to 330 to determine if a valid voiced portion was received. If a valid voiced portion is not received (NO), the methodology returns to 310. If a valid voiced portion is received (YES), the methodology advances to 340 and sets the threshold level to a lower voltage level to monitor for an unvoiced portion.

At 350, the methodology begins monitoring the digital pulse waveform associated with the input signal and one or more pulse characteristics are determined. For example, the frequency of the pulses can be measured and this used to determine if a valid unvoiced portion has been received. Alternatively, the pulse count can be read and can be used to determine whether the count falls within a predetermined range. For example, the count can be checked within a time period or frame (e.g., 20 ms) to determine if a valid unvoiced portion has been found. The validation can be repeated for a series of frames (e.g., 3 or more frames) to assure a valid unvoiced portion has been received. The methodology then proceeds to 360 to determine if a valid unvoiced portion was received. If a valid unvoiced portion is not detected (NO), the methodology determines that a word 2 match has occurred. If a valid unvoiced portion is detected (YES), the methodology determines that a word 1 match has occurred. Appropriate actions can then be taken based on the matched word.

What has been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A speech recognition system comprising:
a conversion circuit operative to convert a speech waveform into a digital pulse waveform; and
an analysis system that analyzes one or more characteristics of the digital pulse waveform to determine a spoken word corresponding to the speech waveform from a set of selectable words, the analysis system operative to adjust a threshold level corresponding to converting the speech waveform into a digital pulse waveform to analyze portions of the speech waveform at different amplitude levels.

2. The system of claim 1, the conversion circuit comprising a comparator that receives the speech waveform and compares the speech waveform to the threshold level provided by a threshold level shifter circuit.

3. The system of claim 2, the threshold level shifter circuit operative to change the threshold level based on a state of a single digital output.

4. The system of claim 2, the threshold level shifter circuit operative to modify a threshold level of the comparator at one or more threshold levels.

5. The system of claim 2, the threshold level shifter circuit operative to change between three threshold levels based on a state of a single digital output having a high impedance state, a low digital state and a high digital state.

6. The system of claim 2, the threshold level shifter circuit operative to change between three threshold levels based on a state of two digital signals.

7. The system of claim 1, further comprising a microphone that converts a spoken word into an electrical signal and an amplifier that amplifies the electrical signal into a speech waveform having one or more characteristics at distinguishable levels, the amplifier coupled to the comparator.

8. The system of claim 1, the one or more characteristics being at least one of speech waveform modulation amplitude, speech waveform modulation frequency and speech waveform duration.

9. The system of claim 1, the analysis system comprising a microcontroller programmed to analyze one or more characteristics of the digital pulse waveform and compare the one or more characteristics to stored characteristics associated with a set of words to determine the spoken word from the set of words.

10. The system of claim 1, the analysis system comprising a control logic component operative to analyze one or more characteristics of the digital pulse waveform and compare the one or more characteristics to stored characteristics associated with a set of words to determine the spoken word from the set of words.

11. A system for distinguishing between spoken words, the system comprising:
an amplifier that amplifies an electrical signal corresponding to a spoken word and provides a speech waveform having one or more characteristics at distinguishable levels;
a comparator that converts the speech waveform into a digital pulse waveform based on comparing the speech waveform to a threshold level; and
a threshold level shifter circuit that provides a voltage corresponding to the threshold level, the threshold level shifter circuit operative to provide two or more different threshold levels based on an input state of the threshold level shifter circuit.

12. The system of claim 11, the threshold level shifter circuit operative to change the threshold level based on a state of a single digital signal.

13. The system of claim 11, the threshold level shifter circuit operative to modify the threshold level of the comparator at one or more threshold levels.

14. The system of claim 11, the threshold level shifter circuit operative to change three threshold levels based on a state of a single digital output having a high impedance state, a low digital state and a high digital state.

15. The system of claim 11, the threshold level shifter circuit operative to change between three threshold levels based on a state of two digital signals.

16. The system of claim 11, further comprising a microcontroller programmed to analyze one or more characteristics of the digital pulse waveform and compare the one or more characteristics to stored word profiles associated with a set of words to determine the spoken word from the set of words.

17. The system of claim 11, further comprising a microcontroller programmed to change the state of the threshold level circuit so that different portions of a speech waveform having different amplitudes can be converted to a digital pulse waveform for analysis of the one or more characteristics.

18. The system of claim 17, the different portions comprising voiced portions and unvoiced portions.

19. The system of claim 17, the microcontroller being programmed to determine between a word having a voiced portion and an unvoiced portion and a word having a voiced portion only.

20. The system of claim 19, the microcontroller being programmed to detect receipt of a voiced portion of a speech waveform, change the threshold level of the comparator through the threshold level circuit upon detecting receipt of a voiced portion and determine receipt of an unvoiced portion.

21. The system of claim 20, the voiced portion being detected by monitoring amplitude and frequency of the speech waveform and the unvoiced portion being detected by monitoring frequency of the speech waveform.

22. The system of claim 11 being one of an electronic toy, an educational aid, an entertainment product and a communication system.

23. A speech recognition system comprising:
means for transforming a spoken word into a speech waveform;
means for converting the speech waveform into a digital pulse waveform; and
means for shifting a threshold level associated with converting the speech waveform into a digital pulse waveform.

24. The system of claim 23, further comprising means for analyzing one or more characteristics of the digital pulse waveform and determining the spoken word from a subset of selectable spoken words.

25. A method for distinguishing a spoken word between a set of selectable words, the method comprising:
transforming a spoken word into a speech waveform;
converting the speech waveform into a digital pulse waveform based on a threshold level;
determining one or more characteristics associated with the digital pulse waveform; and
matching the determined one or more characteristics associated with the digital pulse waveform to one or more stored characteristics associated with a set of selectable words to determine the spoken word.

26. The method of claim 25, further comprising adjusting the threshold level so that one or more characteristics of a different portion of the speech waveform can be determined.

27. The method of claim 25, the one or more characteristics being at least one of speech waveform modulation amplitude, speech waveform modulation frequency and speech waveform duration.

28. The method of claim 25, the determining one or more characteristics associated with the digital pulse waveform comprising counting the number of pulses of the digital pulse waveform to determine the frequency of at least a portion of the speech waveform.

29. The method of claim 25, the determining one or more characteristics associated with the digital pulse waveform comprising determining the time between pulses of the digital pulse waveform to determine the frequency of at least a portion of the speech waveform.

30. The method of claim 25, the determining one or more characteristics associated with the digital pulse waveform comprising monitoring the frequency of the pulses of the digital pulse waveform to determine if a voiced portion of a speech waveform has been detected, changing the threshold level upon detecting receipt of a voiced portion to monitor for an unvoiced portion of a speech waveform and determining if an unvoiced portion of a speech waveform has been r eceived by monitoring the frequency of the pulses of the digital pulse waveform at the changed threshold level.

31. The method of claim 30, further comprising determining if the speech waveform corresponds to one of a word having a voiced portion and an unvoiced portion and a word having a voiced portion only.

32. The method of claim 25, the one or more stored characteristics associated with a set of selectable words comprising one or more stored word profiles.
